(19) United States
(12) Patent Application Publication
(10) Pub. No.: US 2019/0023620 A1
(43) Pub. Date: Jan. 24, 2019

(54) LIMONENE POLYSTYRENE BLENDS FOR USE IN CONCRETE

(71) Applicants: Darrin Vogeli, Stuart, FL (US); Molly Wells Vogeli, Palm City, FL (US)

(72) Inventor: Darrin Vogeli, Stuart, FL (US)

(21) Appl. No.: 16/042,797

(22) Filed: Jul. 23, 2018

Related U.S. Application Data
(60) Provisional application No. 62/535,323, filed on Jul. 21, 2017.

(51) Int. Cl. C04B 40/00; C04B 24/26; C04B 24/00

(52) U.S. Cl. CPC C04B 40/0039; C04B 2103/0093; C04B 24/001; C04B 24/2676

(57) ABSTRACT

A blended composition for use as an admixture for cementitious materials, compressing polystyrene dissolved in a cyclic terpene, and capable of modifying the strength, plasticity, and water-permeability of the cement.

### RELATED APPLICATION(S)

This application claims the benefit of U.S. patent application Ser. No. 62/535,323 filed Jul. 21, 2017 in the name of the inventor, Darrin Vogeli.

### FIELD OF THE INVENTION

The present invention relates to admixtures for use in cementitious material and the like.

### BACKGROUND

Cementitious materials such as concrete and mortar have been used by mankind to produce strong and durable structures since antiquity. The most commonly used cement in modern construction is portland cement, the raw components of which are lime, silica, alumina, and iron oxide. These materials are pulverized into a fine powder and heated in a kiln. After cooling, a small amount of gypsum is added to produce portland cement.

Admixtures are chemical ingredients, other than the cementitious material, water, and aggregate, that are added to the mix immediately before or during the mixing process. Admixtures exist that modify numerous properties of the cementitious material, including the set retention, air entrainment, necessary amount of water, set time, shrinkage, plasticity, and susceptibility to corrosion. These properties have direct bearing on the final strength and durability of the finished concrete. Furthermore, the cost of the admixtures can significantly impact the cost of producing a concrete structure, with many current admixtures adding significant cost to the project, thus reducing the economic viability of cement as a building material.

Also of great concern in modern life is the prevalence of plastic waste. One of the most common forms of plastic is polystyrene, a synthetic polymer that can be either solid or foamed. The numerous advantageous properties of polystyrene result in several million tons of the plastic being produced each year, much of which ends up being discarded as waste. Polystyrene is exceptionally slow to biodegrade, and as a result, this waste perpetually remains in landfills and accumulates in the environment. Until humanity is able to reduce its dependence on polystyrene, an effective means of sequestering polystyrene waste will need to be found.

It is the aim of the present invention to provide such a means of effectively reducing polystyrene waste by sequestering it within our building materials, while simultaneously improving certain physical properties of those building materials.

### SUMMARY OF THE INVENTION

The above discussed disadvantages of the prior art are overcome by the admixture of the present invention that simultaneously sequesters polystyrene while improving certain physical properties of the cementitious material to which it is added.

Thus, it is one aspect of the present invention to provide an admixture for use with cementitious materials comprising polystyrene. The chemical properties of polystyrene make it useful as an admixture. In certain embodiments, the polystyrene will be derived from post-consumer sources, thus providing a method of sequestering a compound that would otherwise become long-lasting waste within the building materials of our society.

It is another aspect of the present invention to use an environmentally friendly solvent to dissolve the polystyrene in order to produce an admixture for use with cementitious materials. In certain embodiments of the present invention, the polystyrene will be dissolved in a naturally occurring solvent, such as a cyclic terpene.

It is yet another aspect of the present invention to provide an admixture for use with cementitious materials that modifies the physical properties the cementitious material to which it is added. In certain embodiments, the admixture of the present invention may modify any of following: the plasticity/slump of the cementitious material prior to setting, the strength of the finished concrete, and the water-permeability of the finished concrete.

Thus, it is one embodiment of the present invention to provide an admixture composition for modifying a cementitious material, the composition comprising: i. a cyclic terpene based solvent, and ii. a polystyrene dissolved in said cyclic terpene to form a blended composition.

It is another embodiment of the present invention to provide such a composition, wherein said cyclic terpene based solvent comprises at least one cyclic terpene selected from a group consisting of limonene, camphor, menthol, carvone, terpinol, alpha-lonone, thujone, and eucalyptol.

It is yet another embodiment of the present invention to provide such a composition, wherein said cyclic terpene based solvent comprises d-limonene.

It is still another embodiment of the present invention to provide such a composition, wherein said blended composition comprises at least 10% polystyrene, by weight.

It is another embodiment of the present invention to provide a method of modifying a cementitious material, the method comprising: i. producing a cementitious material; and ii. adding a blended composition comprising a cyclic terpene based solvent and polystyrene to said cementitious material.

It is another embodiment of the present invention to provide such a method, wherein said cyclic terpene comprises at least one cyclic terpene selected from a group consisting of limonene, camphor, menthol, carvone, terpinol, alpha-lonone, thujone, and eucalyptol.

It is yet another embodiment of the present invention to provide such a method, wherein said cyclic terpene based solvent comprises d-limonene.

It is still another embodiment of the present invention to provide such a method, wherein said blended composition comprises at least 10% polystyrene, by weight.

These, and other, embodiments of the invention will be better appreciated and understood when considered in conjunction with the following description and the accompanying tables. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### DETAILED DESCRIPTION OF THE INVENTION

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents, and other references mentioned herein are incorporated by reference in their entirety. In case of conflict, the present specification including definitions will control.

An “admixture” is any composition that is added to a cementitious material before or during the mixing process. In certain embodiments of the present invention, the admixture may be in a liquid or semiliquid form. Preferably, the admixture of the present invention will be added to the cementitious material during the mixing process.

A “cementitious material” refers to any material that, when mixed with a liquid such as water, forms a cement- or mortar-like base substance, to which an aggregate may be added. Examples include, but are not limited to, portland cement, fly ash, and ground granulated blastfurnace slag. In certain embodiments of the present invention, the cementitious material is Portland Cement. Preferably, the cementitious material is Type I/II Portland Cement.

The phrase “selecting at least one of a group consisting of X and Y” refers to situations where X is selected alone, Y is selected alone, and where both X and Y are selected together.

One key advantage of the present invention is the ability to sequester polystyrene, thus preventing it from entering the environment. Polystyrene (also known as Poly(1-phenylethene)) is a synthetic aromatic polymer having the following chemical structure:

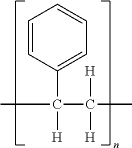

Generally chemically inert, polystyrene is used in the manufacture of many commercially relevant objects. These include expanded polystyrene, such as packaging peanuts and clam-shell containers, as well as vacuum formed and injection molded plastics. Unfortunately, the chemical inertness that underpins the commercial usefulness of polystyrene also prevents it from bio-degrading once it is produced. Generally speaking, the only way to dispose of polystyrene is to incinerate it at extremely high temperatures, or dissolve it in one of the few classes of solvents to which it will react.

Aromatic hydrocarbon based solvents are generally capable of dissolving polystyrene. In one embodiment of the present invention, the polystyrene may be dissolved in such a solvent. Preferably, the solvent will be a cyclic terpene based solvent. Terpenes are large and diverse class of compounds that are naturally produced in many plants, and are generally associated with a strong odor. Cyclic terpenes include, but are not limited to, the following:

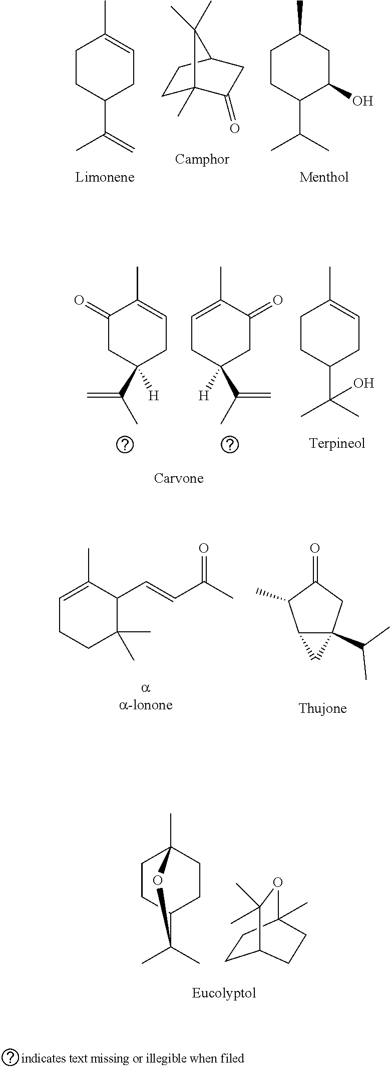

More preferably the solvent will be limonene. Limonene (also known as 1-Methyl-4-(1-methylethenyl)-cyclohexene) is a naturally colorless aromatic hydrocarbon. The d-isomer possesses a strong smell of oranges, and is commonly used as a solvent in so-called “renewables based” or “green” cleaning products. D-limonene can be economically and efficiently produced by either centrifugal separation or steam distillation of citrus fruits, or alternately it may be artificially synthesized. The ease of acquisition and environmentally “friendly” nature of d-limonene make it particularly preferable as a solvent for the present invention.

Thus, in certain embodiments of the present invention, polystyrene is dissolved in a cyclic terpene based solvent to produce a blended composition. In certain embodiments, the polystyrene may come from a post-consumer source, thus preventing accumulation of polystyrene waste in the environment. It will be apparent to those having skill in the art, based on source of polystyrene and additional components that may be present in the polystyrene product, that some degree of pre-processing may be necessary prior to dissolving the polystyrene in the solvent, as contemplated in the present invention.

It will also be apparent that varying amounts of polystyrene may be present in the blended composition, and that the physical properties of the composition may vary based on the amount of polystyrene dissolved therein. By way of example, the weight of the polystyrene may be 1%, 2%, 5%, 10%, 15%, 20%, 25%, 33%, 40%, 50%, and 75% of the blended composition.

The following Working Example provides one exemplary embodiment of the present invention, and is not intended to limit the scope of the invention in any way.

### Working Example

In one embodiment of the present invention, a series of blended compositions having varying amounts of polystyrene dissolved in a cyclic terpene were produced. Table 1 describes the amount of polystyrene relative to the amount of D-limonene, by weight, present in each blended composition:

TABLE 1

| | | Weight of | |
|---|---|---|---|
| Blended | Weight of Polystyrene | D-Limonene | Polystyrene to |
| Composition | (grams) | (grams) | D-Limonene ratio |
| 1 | 2.5 | 2.5 | 1:1 |
| 2 | 2.5 | 10 | 1:4 |
| 3 | 5 | 5 | 1:1 |
| 4 | 5 | 10 | 1:2 |
| 5 | 5 | 20 | 1:4 |
| 6 | 7.5 | 10 | 3:4 |
| 7 | 10 | 10 | 1:1 |
| 8 | 10 | 20 | 1:2 |
| 9 | 15 | 20 | 3:4 |
| Control | 0 | 0 | 0 |

### Mortar Preparation

To determine the usefulness of the blended compositions disclosed in Table 1 as an admixture for a cementitious material, a mortar paste was prepared using the following process. First, type I/II Portland Cement was mixed with water at a ratio of 500 g of water per 1000 g of cement. The water/cement mixture was blended using a mortar/stucco mixing paddle until the mixture was fully blended.

It will be apparent to those having skill in the art that alternate cementitious materials, differing ratios of water to cementitious material, and different mixing techniques may be used, and that aggregates and admixtures may be added to the cementitious material.

### Addition of Blended Compositions

The blended compositions described in Table 1 were used as admixtures for the cementitious material described above. After mixing the cementitious material, the blended compositions were added to the material and fully mixed using a mortar/stucco mixing paddle. Weights of each of the components in each test mortar are described in Table 2.

TABLE 2

| | | | Weight of | |
|---|---|---|---|---|
| | Weight of | Weight of D- | Type I/II | Weight of |
| Test | Polystyrene | Limonene | cement | Water |
| Mortar | (grams) | (grams) | (grams) | (grams) |
| 1 | 2.5 | 2.5 | 1000 | 500 |
| 2 | 2.5 | 10 | 1000 | 500 |
| 3 | 5 | 5 | 1000 | 500 |
| 4 | 5 | 10 | 1000 | 500 |
| 5 | 5 | 20 | 1000 | 500 |
| 6 | 7.5 | 10 | 1000 | 500 |
| 7 | 10 | 10 | 1000 | 500 |
| 8 | 10 | 20 | 1000 | 500 |
| 9 | 15 | 20 | 1000 | 500 |
| Control | 0 | 0 | 1000 | 500 |

The liquid mortar samples to which the blended admixture was added had modified plasticity relative to the control mortar paste. Thus, in certain embodiments of the present invention, the admixtures described herein may be used to modify the slump of a cementitious material prior to setting.

To determine the effect of the blended mixtures on the strength of the set cementitious material, a mortar column was made from each of the test mortars described in Table 2. To prepare the mortar column, the liquid test mortar was poured into a 4″×8″ form to produce a test cylinder of the same dimensions. The test columns were then cured for 8 days. After curing, the cylinders were tested for compressive strength using a compressive test machine, in accordance with American Concrete Institute and ASTM standards. The amount of pressure that each test column was able to withstand before failing is described in Table 3.

TABLE 3

| Test Mortar | Pressure (PSI) |
|---|---|
| 1 | 4680 |
| 2 | 4880 |
| 3 | 4250 |
| 4 | 4010 |
| 5 | 3350 |
| 6 | 4920 |
| 7 | 4160 |
| 8 | 4280 |
| 9 | 4530 |
| Control | 5090 |

Only one test column for each mixture was tested in this initial study, and as such care must be exercised when analyzing the results. However, two main points are apparent from this initial data set. First, the use of the polystyrene/D-limonene admixture resulted in only a minor reduction in the overall strength of the mortar column. Secondly, it appears that much of the reduction in strength is a function of the amount of D-limonene that is present in the blended mixture.

It will also be apparent to those having skill in the art that the mortar columns tested in the above experiment contained no aggregate material. The addition of aggregate to a cementitious material can have a dramatic impact on the strength of the resulting concrete, and it is anticipated that the admixture of the present invention will have a synergistic effect when combined with such aggregates.

Furthermore, both the polystyrene and the cyclic terpene are highly hydrophobic. As such, in certain embodiments of the present invention, the blended composition described herein enhances the resistance to water penetration of the cementitious material to which it is added. Such waterproofing can dramatically improve the ability of concrete to resist harsh environmental conditions and corrosion.

Numerous chemical structures are disclosed herein. The compounds of the present invention also include any derivative compounds with a similar biological activity. It is within the skill of the art to make derivative structures of the disclosed chemical compounds using the disclosures of the present application and those that are incorporated by reference. Such derivative compounds include, but are not limited to, substitutions, additions, analogs, and chimeric variants.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

I claim:

1. An admixture composition for modifying a cementitious material, the composition comprising:
i. a cyclic terpene based solvent; and
ii. a polystyrene dissolved in said cyclic terpene to form a blended composition.

2. The composition of claim 1, wherein said cyclic terpene based solvent comprises at least one cyclic terpene selected from a group consisting of limonene, camphor, menthol, carvone, terpinol, alpha-lonone, thujone, and eucalyptol.

3. The composition of claim 1, wherein said cyclic terpene based solvent comprises d-limonene.

4. The composition of claim 1, wherein said blended composition comprises at least 10% polystyrene, by weight.

5. A method of modifying a cementitious material, the method comprising:
i. producing a cementitious material; and
ii. adding a blended composition comprising a cyclic terpene based solvent and polystyrene to said cementitious material.

6. The method of claim 5, wherein said cyclic terpene comprises at least one cyclic terpene selected from a group consisting of limonene, camphor, menthol, carvone, terpinol, alpha-lonone, thujone, and eucalyptol.

7. The method of claim 5, wherein said cyclic terpene based solvent comprises d-limonene.

8. The method of claim 5, wherein said blended composition comprises at least 10% polystyrene, by weight.
